(19) United States
(12) Patent Application Publication
(10) Pub. No.: US 2023/0353029 A1
(43) Pub. Date: Nov. 2, 2023

(54) ASSEMBLABLE MODULAR AND DISC CORELESS PERMANENT MAGNET SUPERCONDUCTING ULTRA-EFFICIENT MOTOR

(71) Applicant: Beijing Yewei Technology Co., Ltd., Beijing (CN)

(72) Inventors: Peisheng Zhang, Beijing (CN); Lei Xu, Beijing (CN)

(21) Appl. No.: 18/300,113

(22) Filed: Apr. 13, 2023

(30) Foreign Application Priority Data
Apr. 30, 2022 (CN) 2022104767708

(51) Int. Cl. H02K 55/00; H02K 1/27; H02K 1/04

(52) U.S. Cl. CPC H02K 55/00; H02K 1/27; H02K 1/04; H02K 2201/03; H02K 2201/15

(57) ABSTRACT

An assemblable modular and disc coreless permanent magnet superconducting ultra-efficient motor comprises a junction box, a housing, bearings, a rotating shaft, rotors, a stator, and air gaps; the housing comprises a left and a right end cover, the rotors comprise a left and right rotor; both left and right rotor comprise 2N pairs of left or right rotor poles and rotor yokes; the stator comprises a stator armature disc and stator windings, the bearings comprise a left and right bearing, and the air gaps comprise a left and right air gap. The rotor's magnetic field is replaced by high-temperature resistant rare earth high-intensity permanent magnets, and the rotor's electrically excited magnetic field is replaced by permanent magnets, eliminating rotor's copper and iron losses. The winding superconducting wires eliminate stator's copper loss, and stator iron core removal eliminates stator's iron and magnetic saturation loss, improving the efficiency and torque output.

### 1. TECHNICAL FIELD

The invention relates to the field of motor technology, in particular to an assemblable modular and disc coreless permanent magnet superconducting ultra-efficient motor.

### 2. BACKGROUND ART

For more than one hundred years of the invention and application of motors, electric power experts from all countries have been devoted to reducing the losses of motors. Reduction of weight and volume, improvement of motor efficiency, reduction of motor losses and improvement of efficiency are faced by the electric power experts of all countries. Although various kinds of efficient motors have been developed, it is challenging to continue to reduce the loss per unit kilowatt of motor because the primary raw materials affecting the loss of motor are standard copper wire, stator core, rotor structure and the comprehensive loss of long radial flux magnetic circuit of traditional motor have not been significantly improved.

The existing problems of motors in the prior arts are as follows: high motor noise and utilization of forced air cooling. When the load rate is relatively high, or the ambient temperature is relatively high, the temperature rise of the motor also increases, and there are many fire cases caused by such motors; at the same time, the motor loss is also very serious with low efficiency and low torque output. Therefore, the assemblable modular and disc coreless permanent magnet superconducting ultra-efficient motor can solve the above problems.

### 3. SUMMARY OF THE INVENTION

The technical problem to be solved by the invention is the existing problems of motors in the prior arts: high motor noise and utilization of forced air cooling. When the load rate is relatively high, or the ambient temperature is relatively high, the temperature rise of the motor also increases, and there are many fire cases caused by such motors; at the same time, the motor loss is also severe with low efficiency and low torque output.

To solve the above-mentioned technical problem, the technical solution provided by the invention is as follows: an assemblable modular and disc coreless permanent magnet superconducting ultra-efficient motor, wherein the motor is an N-pole motor, and the motor comprises a junction box, a housing, bearings, a rotating shaft, rotors, a stator and air gaps; the housing comprises a left end cover and a right end cover, and the rotor s comprise a left rotor and a right rotor; the left rotor comprises 2N pairs of left rotor poles and left rotor yokes, and the right rotor comprises 2N pairs of right rotor poles and right rotor yokes; the stator comprises a stator armature disc and stator windings, the bearings comprise a left bearing and a right bearing, and the air gaps comprises a left air gap and a right air gap.

The junction box is fixed above the housing, and the bearings, rotors, stator and air gaps are provided between the left end cover and the right end cover; the rotating shaft is fixed between the left end cover and the right end cover through bearings, one end of the rotating shaft passes through the right end cover, and the left end cover and the right end cover are provided in removable connection.

The left air gap is provided between the left rotor poles and the stator, and the right air gap is provided between the right rotor poles and the stator; the stator is provided between the left air gap and the right air gap; the left rotor yokes and right rotor yokes are fixed to the rotating shaft, and the left bearing is provided on the rotating shaft; the left bearing is provided on the left side of the left rotor yokes, and the right bearing is provided on the right side of the right rotor yokes; the stator windings are all encapsulated in the stator armature disc.

Further, the stator windings comprise 3N coils, and every single coil is provided in the sector shape without a stator core.

Further, the stator windings are wound by the single-layer winding method.

Further, the left rotor and right rotor are provided in a left-right symmetrical structure.

Further, the left rotor poles are provided in the sector shape, and the left rotor poles are evenly fixed on the left rotor yokes; the left rotor is provided with 2N permanent magnet poles; the polarity of adjacent permanent magnets on the left rotor and right rotor is opposite, and the polarity of the corresponding permanent magnets on the left rotor and right rotor is same; the 2N pairs of reversed magnetic fields are formed in the air gaps provided between the left rotor poles and the right rotor poles.

Further, the magnetic flux direction of the air gaps is parallel to the centerline of the rotating shaft.

Further, the encapsulation material for encapsulating the stator windings is a high-strength epoxy resin insulation material.

Further, the N is an even number.

Compared to the prior arts, the invention has the following advantages and beneficial effects: the invention adopts the cooperative structure of the junction box, the housing, the bearings, the rotating shaft, the rotors, the stator and the air gaps, and the rotor magnetic field is directly replaced by the high-temperature resistant rare earth high-intensity permanent magnet, resulting in the no copper loss and iron loss in the rotor of the motor to facilitate the high torque output of the motor. After removing the core from the stator, the invention only adopts room temperature semi-superconducting electromagnetic wires wound into 3N sector-shaped windings regularly encapsulated in the disc, with high-strength epoxy resin insulation material as the encapsulation material, providing sufficient strength for the encapsulated disc. Since the stator windings remove the iron core and the winding electromagnetic wire adopts superconducting wire, the stator has no copper loss, iron core iron loss or magnetic saturation loss. The invention removes the thermal fin and cooling fan to eliminate the wind friction loss, reducing the electric loss significantly to a negligible level. Since the magnetic flux is provided in the axial direction with the shorter magnetic circuit, the motor efficiency is greatly improved. Since the motor adopts the way of single-chip superposition to increase the power, the invention also saves the installation cost and installation space significantly.

The critical design of the high-power density of the invention is the motor without transverse magnetic slots. With two rotors on each side of the stator inside the motor, the motor has an extremely short magnetic flux path, and the permanent magnets are farther away from the shaft center, resulting in higher efficiency and leverage near the mid-shaft. The invention has no overhang with 100% of the windings in operation, and the double permanent magnet rotors are provided for outputting the highest possible torque to weight ratio. The no transverse stator is provided for the shortest possible flux path, the rectangular cross-section semi-superconducting electromagnetic wires are provided for 90% of the possible wire filling factor, and the concentrated windings are provided for the lowest possible losses. The invention performs well in a wide speed range to obtain 99.99% high efficiency, making it applicable to high-speed low torque and low-speed high torque applications; in brief, the invention is well-designed to be promoted significantly.

### 4. BRIEF DESCRIPTION OF ACCOMPANY DRAWINGS

FIG. 1 is a schematic diagram showing the structure of the assemblable modular and disc coreless permanent magnet superconducting ultra-efficient motor provided by the invention.

FIG. 2 is a schematic diagram showing the cross-section of the assemblable modular and disc coreless permanent magnet superconducting ultra-efficient motor provided by the invention.

FIG. 3 is a schematic diagram showing the structure of the rotor in the assemblable modular and disc coreless permanent magnet superconducting ultra-efficient motor provided by the invention.

FIG. 4 is a schematic diagram showing the rotor' s structure in the prior art's three-phase asynchronous motor.

In the FIGS., 1. the motor; 2. the junction box; 3. the housing; 4. the bearings; 5. the rotating shaft; 6. the rotors; 7. the stator; 8. the air gaps; 9. the left end cover; 10. the right end cover; 11. the left rotor; 12. the right rotor; 13. the left rotor poles; 14. the left rotor yokes; 15. the right rotor poles; 16. the right rotor yokes; 17. the stator armature disc; 18. the stator windings; 19. the left bearing; 20. the right bearing; 21. the left air gap; 22. the right air gap.

### 5. SPECIFIC EMBODIMENT OF THE INVENTION

To make the technical solutions provided by the invention more comprehensible, a further description of the invention is given below in combination with the attached drawings and embodiments, and the embodiments are exemplary and not the limitations of the scope of the disclosure.

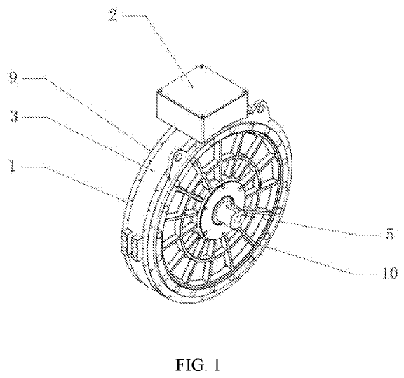

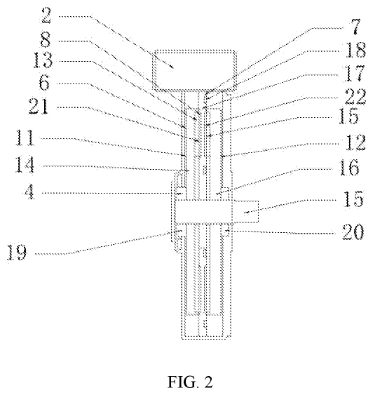

As shown in FIG. 1-FIG. 4, the invention is described in detail.

An assemblable modular and disc coreless permanent magnet superconducting ultra-efficient motor, wherein motor 1 is an N-pole motor and motor 1 comprises a junction box 2, a housing 3, bearings 4, a rotating shaft 5, rotors 6, a stator 7 and air gaps 8; the housing 3 comprises a left end cover 9 and a right end cover 10, and the rotors 6 comprise a left rotor 11 and a right rotor 12; the left rotor 11 comprises 2N pairs of left rotor poles 13 and left rotor yokes 14, and the right rotor 12 comprises 2N pairs of right rotor poles 15 and right rotor yokes 16; the stator 7 comprises a stator armature disc 17 and stator windings 18, the bearings 4 comprise a left bearing 19 and a right bearing 20, and the air gaps 8 comprises a left air gap 21 and a right air gap 22.

The junction box 2 is fixed above housing 3, and bearings 4, rotors 6, stator 7 and air gaps 8 are provided between the left end cover 9 and the right end cover 10; the rotating shaft 5 is fixed between the left end cover 9 and the right end cover 10 through bearings 4, one end of the rotating shaft 5 passes through the right end cover 10, and the left end cover 9 and the right end cover 10 are provided in removable connection.

The left air gap 21 is provided between the left rotor poles 13 and the stator 7, and the right air gap 22 is provided between the right rotor poles 15 and the stator 7; the stator 7 is provided between the left air gap 21 and the right air gap 22; the left rotor yokes 14 and right rotor yokes 16 are fixed to the rotating shaft 5, and the left bearing 19 is provided on the rotating shaft 5; the left bearing 19 is provided on the left side of the left rotor yokes 14, and the right bearing 20 is provided on the right side of the right rotor yokes 16; the stator windings 18 are all encapsulated in the stator armature disc 17.

The stator windings 18 comprise 3N coils, and every single coil is provided in the sector shape without a stator core.

The stator windings 18 are wound by the single-layer winding method.

The left rotor 11 and right rotor 12 are provided in a left-right symmetrical structure.

The left rotor poles 13 are provided in the sector shape, and the left rotor poles 13 are evenly fixed on the left rotor yokes 14; the left rotor 11 is provided with 2N permanent magnet poles; the polarity of adjacent permanent magnets on the left rotor 11 and right rotor 12 is opposite, and the polarity of the corresponding permanent magnets on the left rotor 11 and right rotor 12 is same; the 2N pairs of reversed magnetic fields are formed in the air gaps 8 provided between the left rotor poles 13 and the right rotor poles 15.

The magnetic flux direction of air gaps 8 is parallel to the centerline of the rotating shaft.

The encapsulation material for encapsulating the stator windings 18 is high-strength epoxy resin insulation material.

The N is an even number.

The specific implementation of the assemblable modular and disc coreless permanent magnet superconducting ultra-efficient motor has the following steps:

The left rotor poles 13, which are 2N sector-shaped permanent magnets, are fixed evenly and firmly on the inner circle of the left rotor yokes 14, and then the left rotor yokes 14 are installed on the left end of the rotating shaft 5, and then the left end of the rotating shaft 5 is fixed on the left end cover 9 through the left bearing 19. The left rotor is allowed to rotate freely, and then the stator armature disc is fixed on the right side of the left rotor yokes 14 inside the left end cover outer circle firmly. The stator 7 leads are connected to junction box 2, and the right rotor poles 15, which are 2N sector-shaped permanent magnets, are fixed evenly and firmly on the inner circle of the right rotor yokes 16. The right rotor yokes 16 are fixed on the right side of the stator on the rotating shaft 5, and then fixed on the right end cover 10 through the right bearing 20. One end of rotating shaft 5 is passed through the right end cover 10, and the stator 7 is provided in the air gaps 8 between the left rotor 11 and the right rotor 12 with the outer circle fixed to the inner circle of the housing. The left rotor 11 and right rotor 12 are fixed to the left and right ends of the stator 7, which can be freely rotated by the left bearing 19 and right bearing 20 inside the combined left and right end covers, and the left end cover 9 and the right end cover 10 are provided in removable connection.

The invention adopts the cooperative structure of the junction box, the housing, the bearings, the rotating shaft, the rotors, the stator and the air gaps, and the rotor magnetic field is directly replaced by the high-temperature resistant rare earth high-intensity permanent magnet, resulting in the no copper loss and iron loss in the rotor of the motor. The stator is wound with room temperature semi-superconducting electromagnetic wires to make 3N three groups of sector-shaped windings divided into A, B, and C three phases and to be regularly encapsulated in the armature disc, and the encapsulated disc has sufficient strength since the encapsulation material is epoxy resin insulation material. Since the stator windings remove the iron core and the winding electromagnetic wire adopts superconducting wire, the stator has no copper loss, iron core iron loss or magnetic saturation loss. The invention removes the thermal fin and cooling fan to eliminate the wind friction loss, reducing the electric loss significantly to a negligible level. Since the magnetic flux is provided in the axial direction with the shorter magnetic circuit, the motor efficiency is greatly improved. Since the motor adopts the way of single-chip superposition to increase the power, the invention also saves the installation cost and installation space significantly.

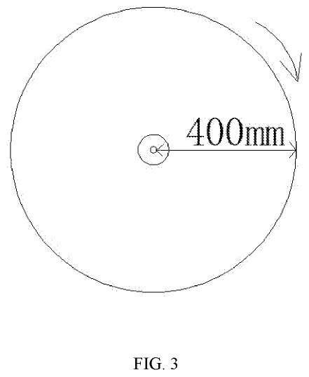

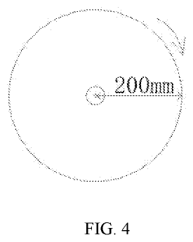

FIG. 3 and FIG. 4 provide a comparison of the rotor of the motor with the same rated power and rated speed. In the assemblable modular and disc coreless permanent magnet superconducting ultra-efficient motor, the torque lever of the rotor is much larger than that of the three-phase asynchronous motor with the same rated power and rated speed in the prior art, significantly increasing the torque output of the assemblable modular and disc coreless permanent magnet superconducting ultra-efficient motor. The critical design of the high-power density of the invention is the motor without transverse magnetic slots. With two rotors on each side of the stator inside the motor, the motor has an extremely short magnetic flux path, and the permanent magnets are farther away from the shaft center, resulting in higher efficiency and leverage near the mid-shaft. The invention has no overhang with 100% of the windings in operation, and the double permanent magnet rotors are provided for outputting the highest possible torque to weight ratio. The no transverse stator is provided for the shortest possible flux path, the rectangular cross-section semi-superconducting electromagnetic wires are provided for 90% of the possible wire filling factor, and the concentrated windings are provided for the lowest possible losses. The invention performs well in a wide speed range to obtain 99.99% high efficiency, making it applicable to high-speed low torque and low-speed high torque applications; in brief, the invention is well-designed to be promoted significantly.

The invention and the embodiments thereof are described hereinabove, and this description is not restrictive. In summary, structural methods and embodiments similar to the technical solution without departing from the inventive purpose of the invention made by inspired ordinary technicians in the art without creative efforts shall all fall within the protection scope of the invention.

1. An assemblable modular and disc coreless permanent magnet superconducting ultra-efficient motor, wherein the motor is an N-pole motor, and the motor comprises a junction box, a housing, bearings, a rotating shaft, rotors, a stator and air gaps; the housing comprises a left end cover and a right end cover, and the rotors comprise a left rotor and a right rotor; the left rotor comprises 2N pairs of left rotor poles and left rotor yokes, and the right rotor comprises 2N pairs of right rotor poles and right rotor yokes; the stator comprises a stator armature disc, and stator windings, the bearings comprise a left bearing and a right bearing, and the air gaps comprises a left air gap and a right air gap;
the junction box is fixed above the housing, and the bearings, rotors, stator and air gaps are provided between the left end cover and the right end cover; the rotating shaft is fixed between the left end cover and the right end cover through bearings, one end of the rotating shaft passes through the right end cover, and the left end cover and the right end cover are provided in removable connection;
the left air gap is provided between the left rotor poles and the stator, and the right air gap is provided between the right rotor poles and the stator; the stator is provided between the left air gap and the right air gap; the left rotor yokes and right rotor yokes are fixed to the rotating shaft, and the left bearing is provided on the rotating shaft; the left bearing is provided on the left side of the left rotor yokes, and the right bearing is provided on the right side of the right rotor yokes; the stator windings are all encapsulated in the stator armature disc.

2. An assemblable modular and disc coreless permanent magnet superconducting ultra-efficient motor as claimed in claim 1, wherein the stator windings comprise 3N coils, and every single coil is provided in the sector shape without stator core.

3. An assemblable modular and disc coreless permanent magnet superconducting ultra-efficient motor as claimed in claim 2, wherein the stator windings are wound by the single-layer winding method.

4. An assemblable modular and disc coreless permanent magnet superconducting ultra-efficient motor as claimed in claim 1, wherein the left rotor and right rotor are provided in a left-right symmetrical structure.

5. An assemblable modular and disc coreless permanent magnet superconducting ultra-efficient motor as claimed in claim 4, wherein the left rotor poles are provided in the sector shape, and the left rotor poles are evenly fixed on the left rotor yokes; the left rotor is provided with 2N permanent magnet poles; the polarity of adjacent permanent magnets on the left rotor and right rotor is opposite, and the polarity of the corresponding permanent magnets on the left rotor and right rotor is same; the 2N pairs of reversed magnetic fields are formed in the air gaps provided between the left rotor poles and the right rotor poles.

6. An assemblable modular and disc coreless permanent magnet superconducting ultra-efficient motor as claimed in claim 5, wherein the magnetic flux direction of the air gaps is parallel to the centerline of the rotating shaft.

7. An assemblable modular and disc coreless permanent magnet superconducting ultra-efficient motor as claimed in claim 1, wherein the encapsulation material for encapsulating the stator windings is a high-strength epoxy resin insulation material.

8. An assemblable modular and disc coreless permanent magnet superconducting ultra-efficient motor as claimed in claim 1, wherein the N is an even number.
